(19) United States
(12) Patent Application Publication
(10) Pub. No.: US 2025/0344717 A1
(43) Pub. Date: Nov. 13, 2025

(54) RING CANDY CONFECTION

(71) Applicant: Imaginings 3, Inc., Niles, IL (US)

(72) Inventors: Nicole I. Himel, Deerfield, IL (US); Sidney Diamond, Barrington Hills, IL (US)

(73) Assignee: Imaginings 3, Inc., Niles, IL (US)

(21) Appl. No.: 19/202,934

(22) Filed: May 8, 2025

Related U.S. Application Data
(63) Continuation-in-part of application No. 29/941,580, filed on May 10, 2024.
(60) Provisional application No. 63/704,398, filed on Oct. 7, 2024.

(51) Int. Cl. A23G 3/56; A44C 9/00

(52) U.S. Cl. CPC A23G 3/563; A44C 9/0084

(57) ABSTRACT

Decorative ring apparatus having transparent edible candy with its base portion secured and including a finger-grasping portion for the user's finger. Stickers are additionally provided which may be applied to the base portion to form an image. The stickers form a puzzle, with images where stickers may be placed in their correct locations. Moreover, the base portion has an upwardly extending portion, which further secures the edible portion, with upwardly extending portion floating its ball element upon a raised element perceived to appear to the wearing users and observers for an illusion of the ball floating within the edible portion that may be provided as a decorative ball. The combination of the application of the stickers and the decorative ball makes the apparatus more aesthetically pleasing and incentivizes the user to consume the edible portion.

### FIELD OF THE INVENTION

The present invention relates generally to decorative ring apparatus having viewable object aesthetics disposed with edible candy including a finger-grasping portion for the user's finger.

### BACKGROUND OF THE INVENTION

Apparatus securing a candy to a user's finger is a convenient way of consuming the candy. The user can use their hand for other activities as they do not need to grasp the candy apparatus. Having the candy be a ring that is secured to the user's finger gives the candy novelty. Additionally, securing the candy to the user's finger prevents the user from accidentally losing their grip and choking on the candy. Moreover, the apparatus may contain other elements to make the apparatus more entertaining. Such elements may include decorations, such as stickers that form an image on the apparatus when applied. Moreover, the user may be required to place the stickers in the correct locations to form an image, hence making the sticker application a form of puzzle.

There is prior art that has combined candy and ring apparatus that allows a candy to be secured to the user's finger. Securing the candy to the user's finger is safer than simply holding the candy as it is harder for children to choke on the candy. Additionally, securing the candy to the user's finger frees the user's hand that would otherwise be used to grasp the candy. Also, some prior art have ring candy confection apparatus with elements provided for entertainment. For example, a ring candy confection apparatus may have a movable spinning object, or a fidget spinner. The movable spinning object provides entertainment by providing the user with an object to manipulate with their hands. The additional movable spinning object also provides value to the ring candy confection apparatus after the candy has been consumed since the moveable spinning object operates once the candy has been consumed.

None of the prior art allows the user to decorate a ring candy confection apparatus. Other candies have the ability for the user to secure the candy to their finger or have toy elements, but they are not intended for the user to decorate the candy themselves, wear the ring candy confection apparatus as decorative elements or incentivize the user to collect ring candy confection apparatus with different decorative variations. None of the prior art contains a form of puzzle where the user must apply the stickers in their correct locations to form an image. The invention relates to a ring candy confection apparatus with a portion that can be consumed and stickers that allow the user to decorate the ring candy confection apparatus.

### SUMMARY OF THE INVENTION

The ring candy confection apparatus described in detail here provides a novel means of decoration and entertainment for a candy apparatus. The ring candy confection apparatus provides a ring that may be secured to the user's finger as decorative ring apparatus having viewable object aesthetics disposed with a base portion, edible candy and including a finger-grasping portion for the user's finger, the base portion having an upwardly extending portion, which further secures the edible portion, which may be provided as a decorative ball. The apparatus may be provided with transparent edible candy. A decorative ball secures the edible portion to the rest of the ring candy confection apparatus. The decorative ball is visible through the transparent edible portion and provides aesthetic value to the toyetic apparatus.

Once the edible portion has been consumed, the user may apply to form an image with decorative gem jewel like plastics or a sticker. The stickers must be applied in the correct locations, or the image will not be formed. Hence, the sticker application forms a puzzle. The stickers, along with the decorative ball, provide decoration which increases the aesthetic value of the ring candy confection apparatus. The stickers may not be applied until the edible portion has been consumed, thereby incentivizing the user to consume the edible portion so that they may apply the stickers and decorate the ring candy confection apparatus. Also, different ring candy confection apparatus may have different stickers which form different images and different decorative balls. Therefore, different ring candy confection apparatus may have different decorations, which the user may be incentivized to collect.

Briefly summarized, the present invention relates to a ring candy confection apparatus with upwardly extending portion floating a decorative element raised element achieving an illusion such as a ball floating within the edible portion, with later use to decorate the apparatus provided with decorative gem jewel like plastics or stickers forming an image. The stickers must be applied to the correct locations to form an image. A decorative ball may be visible through a transparent candy, increasing the aesthetic value of the ring candy confection apparatus. Moreover, different sticker images and other decorative elements may incentive the user to collect different ring candy confection apparatus with different sticker images and other decorative elements.

The apparatus is constructed with economic and simple parts, yet the decorative aspects of the apparatus provide value after the candy is consumed. The inventive features may be best understood from the following detailed description taken in conjunction with the drawing figures.

### BRIEF DESCRIPTION OF DRAWINGS

For the purpose of facilitating an understanding of the invention, the accompanying drawings and detailed description illustrate preferred embodiments thereof, from which the invention, its structures, its constructions and operations, its processes, and many related advantages may be readily understood and appreciated.

FIG. 1 is a top and front perspective view of the ring candy confection apparatus showing combined box-like candy with viewable object on a ring of our new design;

FIG. 2 is a front elevation view thereof;

FIG. 3 is a rear elevation view thereof;

FIG. 4 is a right side elevation view thereof;

FIG. 5 is a left side elevation view thereof;

FIG. 6 is a top plan view thereof;

FIG. 7 is a bottom plan view thereof, and FIGS. 7A and 7B are further side elevation views illustrating the finger-grasping portion bendable plastic extensions pairs includes a gap between the finger-grasping portion bendable plastic extensions facilitate securing to fingers of different sizes;

FIG. 8A shows an isometric view of the ring candy confection apparatus secured to a user's finger. FIG. 8B shows the ring candy confection apparatus as a decorative element.

FIGS. 9A and 9B shows an isometric view of the finger-grasping portion of the ring candy confection apparatus secured to fingers of various sizes. FIG. 9A shows the finger-grasping portion not secured to a finger and FIG. 9B shows the finger-grasping portion secured to a finger.

FIG. 10A shows an isometric view of the base portion of the ring candy confection apparatus with upwardly extending portion floating a ball element upon a raised element. FIG. 10B shows the underside of the edible portion where it is secured to the base portion.

FIG. 11A shows the decorative gem jewel like plastics or a sticker sheet. FIG. 11B shows the stickers being removed from the sticker sheet. FIG. 11C shows the stickers being applied to the ring candy confection apparatus and the ring candy confection apparatus being transformed into a decorative element. FIG. 11D shows plural ring candy confection apparatus as plural decorative elements secured to plural fingers.

FIG. 12A shows the stickers removed from the sticker sheet. FIG. 12B shows the sticker sheets being stored within the gap of the finger-grasping portion.

FIGS. 13A and 13B show the molding of the base portion and edible portion.

FIGS. 14A and 14B show the finger-grasping portion being secured to the user's finger.

FIGS. 15A and 15B show the edible portion being consumed, the finger-grasping portion being removed from the user's finger, and the base portion being cleaned of any remaining debris from consuming the edible portion.

FIGS. 16A, 16B, 16C and 16D show the application of the stickers. FIG. 16A shows the stickers on the sticker sheet and FIG. 16B shows the stickers being removed from the sticker sheet. FIG. 16C shows the stickers being applied to the ring candy confection apparatus. FIG. 16D show the finger-grasping portion being secured to the user's finger.

FIG. 17 is a top and front perspective view of the ring candy confection apparatus of the instant inventions showing the candy with further radius of curvature combined for object viewing.

### DETAILED DESCRIPTION OF THE EMBODIMENTS

The following description is provided to enable those skilled in the art to make and use the described embodiments set forth in the best mode contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

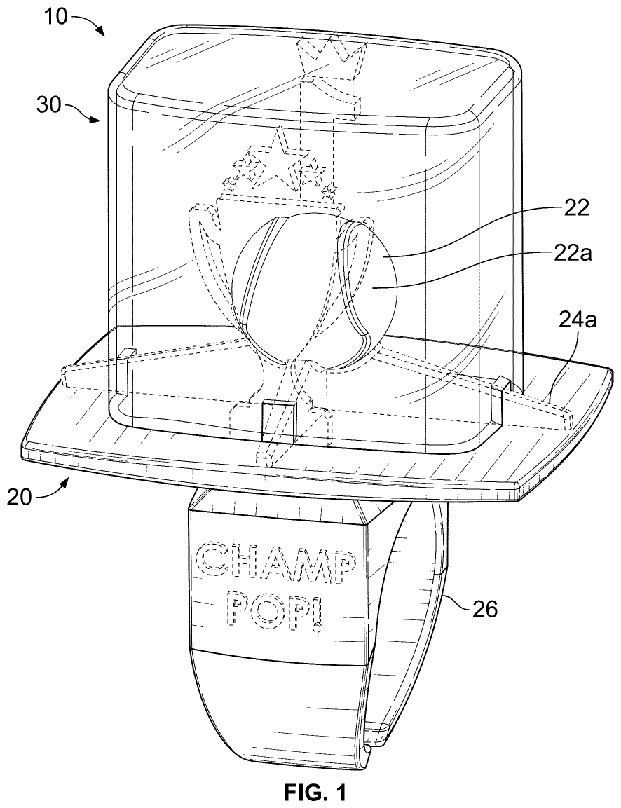

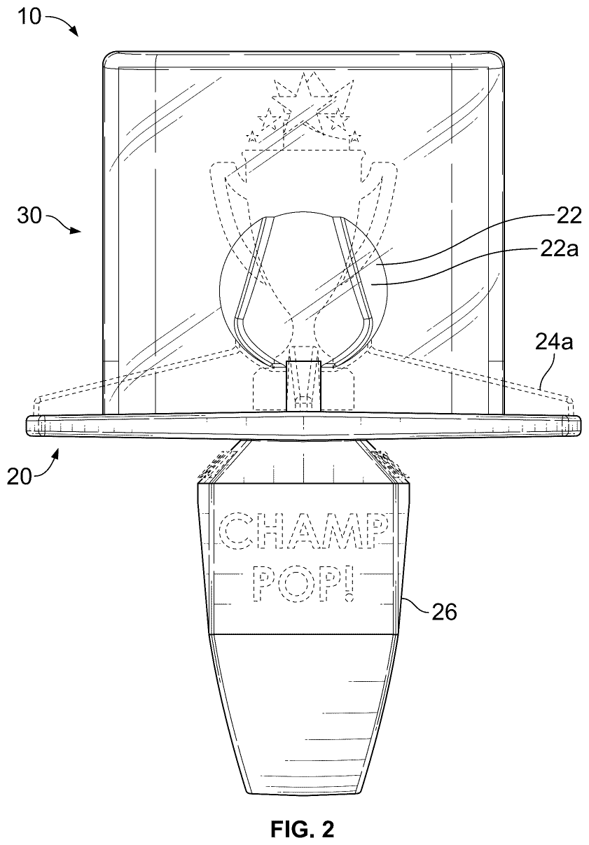

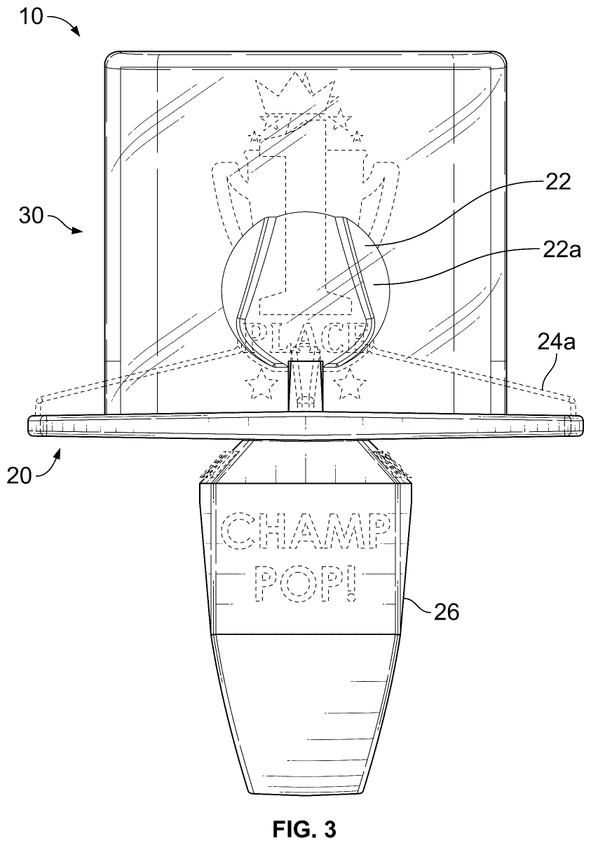

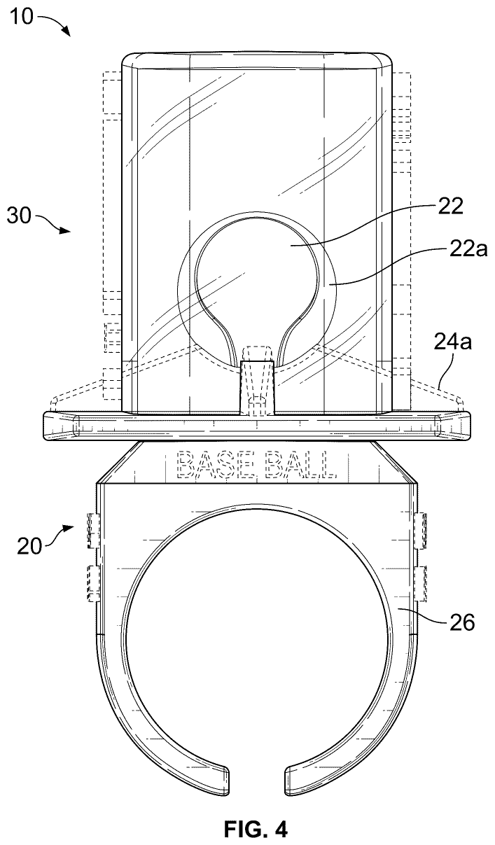

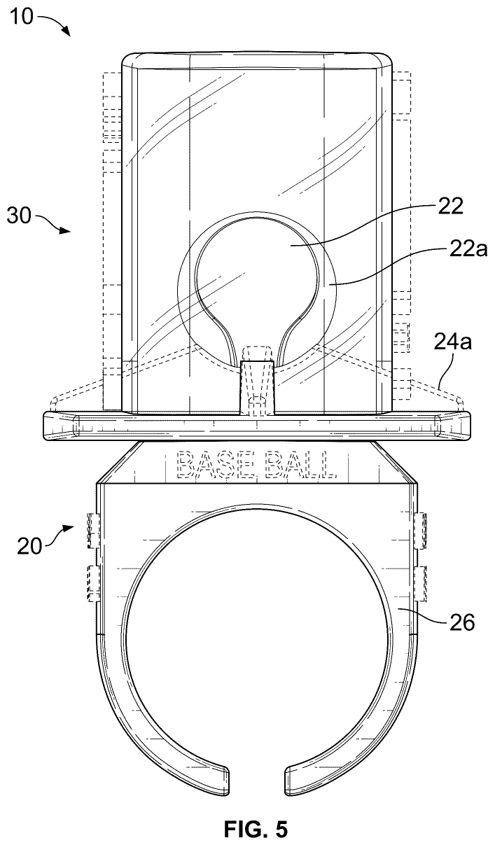

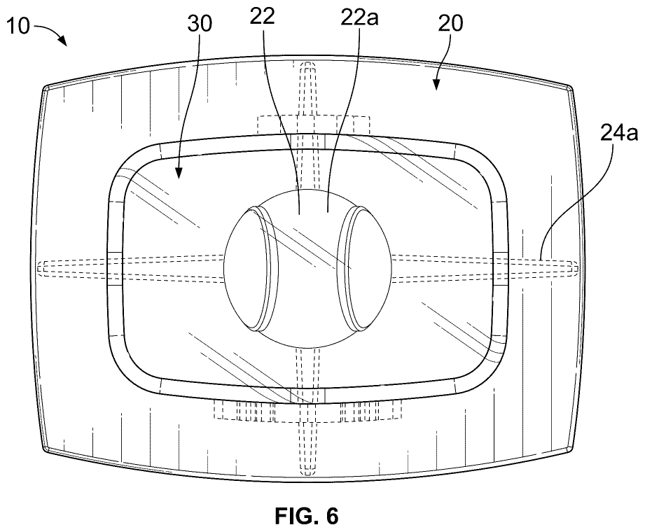

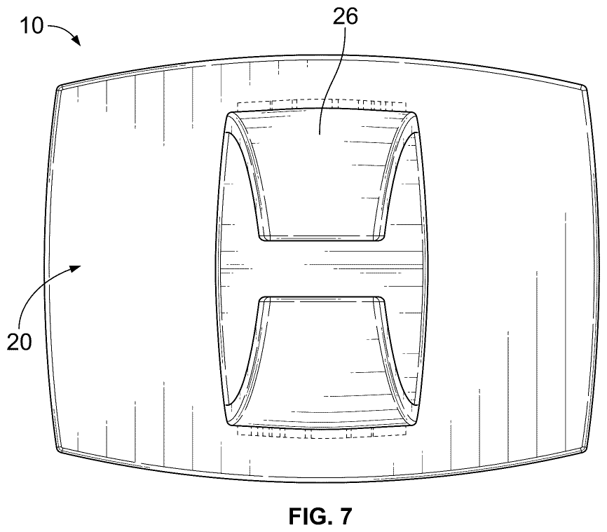

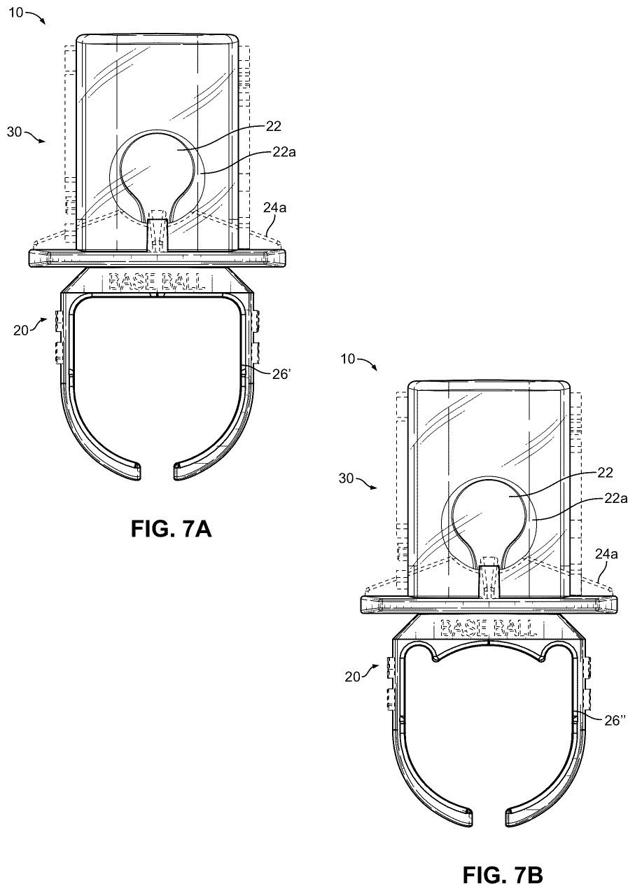

FIGS. 1 through 7, and FIGS. 7A and 7B show a ring candy confection apparatus 10. The ring candy confection apparatus 10 has a box-like candy with a viewable object on a ring. The ring candy confection apparatus 10 has a base portion 20 and an edible portion 30 providing a toyetic candy apparatus. The edible portion 30 is provided as a hard box-shaped edible candy that is consumed by the user. The base portion 20 secures the edible portion 30. The base portion 20 pedestal elements which provided an interference or friction fit for molded candy edible portion 30 thereupon as discussed herein, with upwardly extending portion floating its ball element upon a raised element perceived to appear to the wearing users and observers for an illusion of the ball floating within the edible portion 30, illustrated as ribs 24a and an upwardly extending portion 22 which secure the edible portion 30. The upwardly extending portion 22 is provided as a decorative ball 22a. The edible portion 30 is provided as a transparent candy through which a viewable object, the decorative ball 22a can be seen. The base portion 20 has a finger-grasping portion 26, which can be secured to the user's finger 40. FIGS. 7A and 7B are side elevation views illustrating the base portion 20 with two alternative cornered or hinged extended contour ears of finger-grasping portion 26′ or finger-grasping portion 26″ of a pair of alternate bendable plastic extensions and includes a gap between the finger-grasping portion bendable plastic extensions 26′, 26″. FIGS. 7A, 7B thus allow flexibility fit for thick and skinny fingers facilitate securing to fingers of different sizes the contours in version 2 might be more comfortable and form fitting for matters of larger finger sizings.

The ring candy confection apparatus 10 provides edible candy that is consumed by the user. Additionally, adhering adhesive decorative gem jewel like plastics or stickers 42 are provided that may be applied to the base portion 20 to form an image 42b after the edible portion is consumed. The application of the decorative gem jewel like plastics and the like, such as stickers 42 and forming an image 42b cause the ring candy confection apparatus 10 to become more decorative and aesthetically pleasing. As such, the ring candy confection apparatus 10 is transformed into a decorative element 10a by the application of the stickers 42 and formation of an image 42b. The stickers 42 must be placed in the correct locations on the base portion 20. The image 42b will not be formed if the stickers 42 are placed in any alternative locations. Hence, the application of stickers 42 is a kind of puzzle. The transformation of the ring candy confection apparatus 10 into a decorative element 10a additionally provides incentive to finish the edible portion 20. Different stickers 42 with different images 42b may be provided. Therefore, different decorative elements 10a will have different images 42b when the stickers 42 are applied and the user may be incentivized to collect multiple ring candy confection apparatus 10 with different images 42b. Additionally, the different ring candy confection apparatus 10 may have different sports balls for their decorative balls 22a. This may provide an additional incentive to collect multiple ring candy confection apparatus 10.

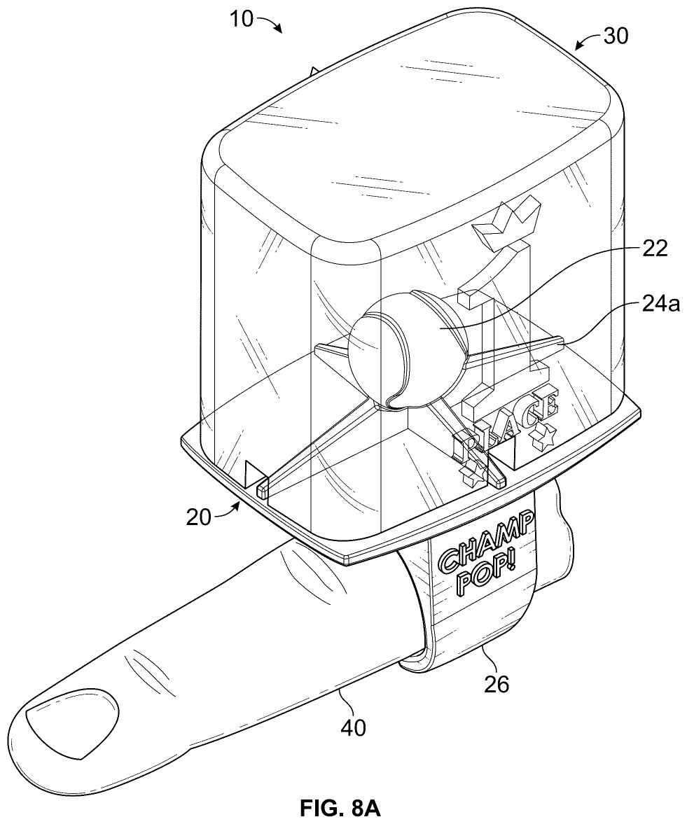

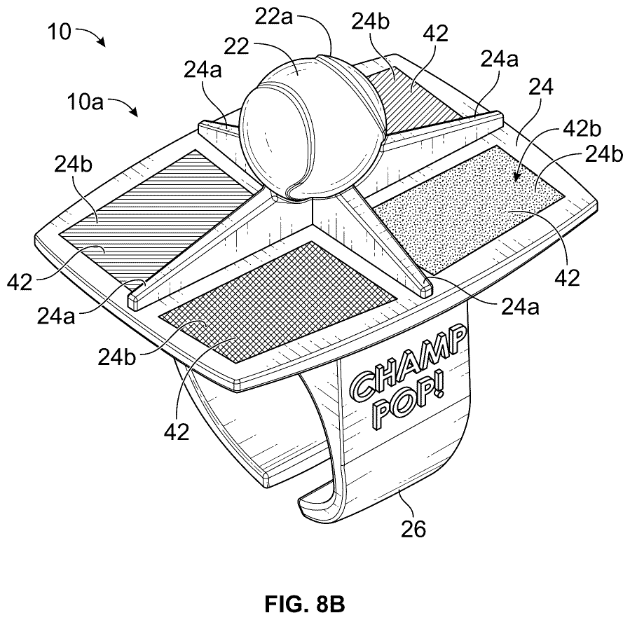

FIG. 8A shows the ring candy confection apparatus 10 secured to a user's finger 40. The base portion 20 has a finger-grasping portion 26 which secures the base portion 20 to the user's finger 40. The ring candy confection apparatus 10 will not move relative to the finger 40 without sufficient force. As such, the user can manipulate the position of the ring candy confection apparatus 10 by moving their FIG. 40 and position the edible portion 30 at the user's mouth for consumption of the edible portion 30. The apparatus allows the user to secure an edible candy to their finger and decorate the apparatus. The apparatus 10 has an edible portion 30, that is provided as a transparent edible candy. The base portion 20 is secured to the edible portion 30 and the base portion 20 has a finger-grasping portion 26 which may be secured to the user's finger 40. Hence, the entire apparatus 10 along with the edible portion 30 may be secured to the user's finger 40.

As shown in FIG. 8B, the ring candy confection apparatus 10 may form a decorative element 10a with the stickers 42 being applied to the base portion sections 24b. The ribs 24a separate the plate 24 into base portion sections 24b on which stickers 42 can be applied to form an image 42b, e.g., which may be provided as puzzle game sticker candy. The upwardly extending portion 22 may be provided as a decorative ball 22a. The application of the stickers 42 forming an image 42b and the decorative ball 22a cause the ring candy confection apparatus 10 to look more aesthetically pleasing. The application of the stickers 42 causes the ring candy confection apparatus 10 to form a decorative element 10a. Stickers 42 are additionally provided which may be applied to the base portion 20 to form an image 42b. The stickers 42 form a puzzle; forming an image 42b requires the stickers 42 to be placed in their correct locations. Moreover, the base portion 20 has an upwardly extending portion 22, which further secures the edible portion 30, which may be provided as a decorative ball 22a. The combination of the application of the stickers 42 and the decorative ball 22a makes the apparatus 10 more aesthetically pleasing and incentivizes the user to consume the edible portion 30 as the stickers 42 may not be applied until the edible portion 30 is consumed. The ring candy confection apparatus with the stickers 42 applied may be worn as a ring through securing the finger-grasping portion 26. Additionally, multiple types of decorative balls 22a and sticker images 42b may be provided, incentivizing the user to collect multiple ring candy confection apparatus 10 with different decorative balls 22a and sticker images 42b. The ring candy confection apparatus 10 as a decorative element 10a is more visually aesthetic than the ring candy confection apparatus 10 absent decorative element 10a.

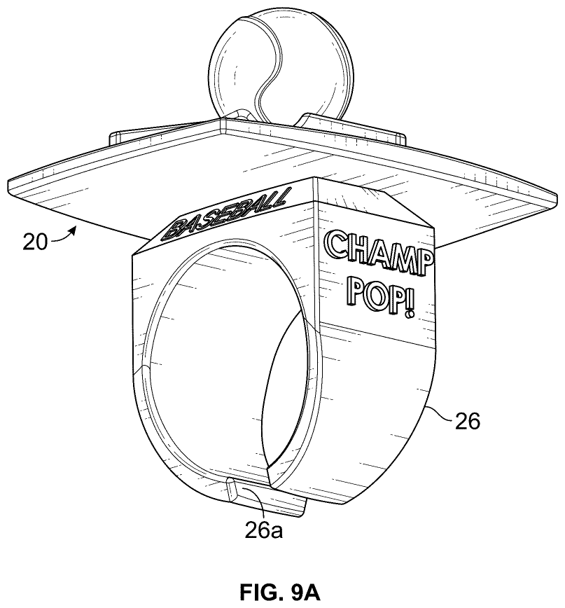

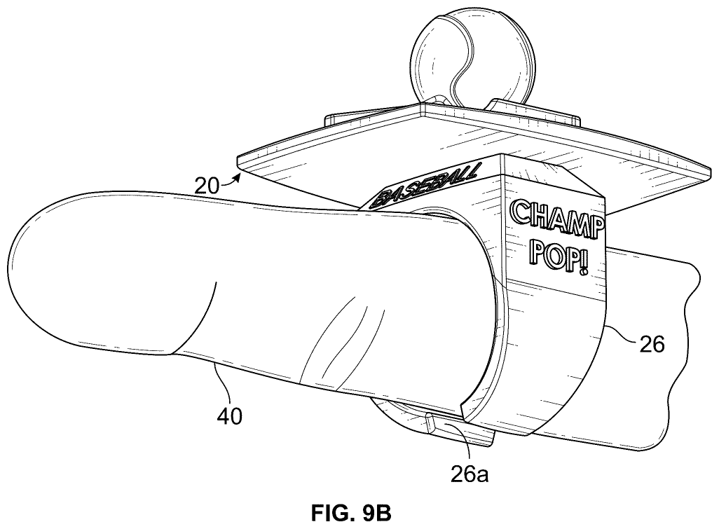

FIGS. 9A and 9B show the finger-grasping portion 26 in more detail. The finger-grasping portion 26 is provided as a ring and secures the ring candy confection apparatus 10 to the user's finger 40. The ring candy confection apparatus 10 is fixed to the finger 40; sufficient force must by applied for the ring candy confection apparatus 10 to move relative to the finger 40. As such, the user may manipulate the position and orientation of the ring candy confection apparatus by moving their finger. The user may position the edible portion 30 at the user's mouth for consumption by moving their finger. FIG. 9B shows the finger-grasping apparatus 26 being secured to a finger. The material of the finger-grasping portion 26 may be provided as a bendable plastic, such as polypropylene. The finger grasping portion 26 may have a gap 26a. The combination of the bendable plastic and gap 26a allows for the finger-grasping portion 26 to deform to multiple sizes. Therefore, different finger sizes may be secured to the finger-grasping portion 26. The finger-grasping portion 26 bends more for bigger finger sizes. Hence, users with different figure sizes may be able to manipulate the position and orientation of the ring candy confection apparatus 10. Users may have different finger sizes as the users may have different ages or hand sizes. The user may use the decorative element 10a as a wearable object.

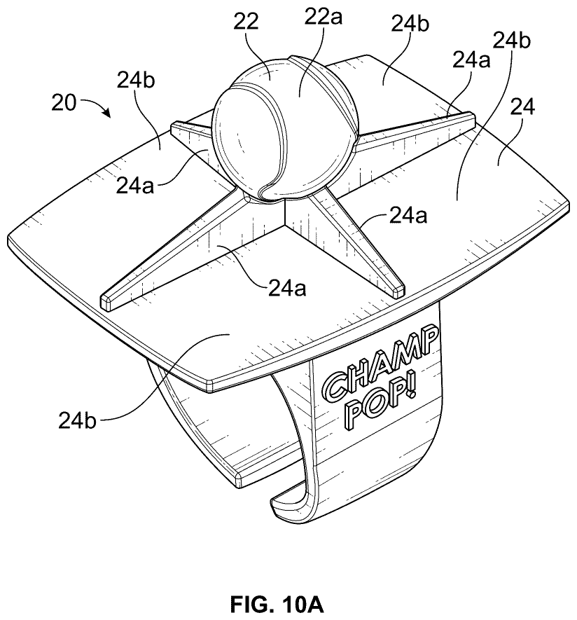

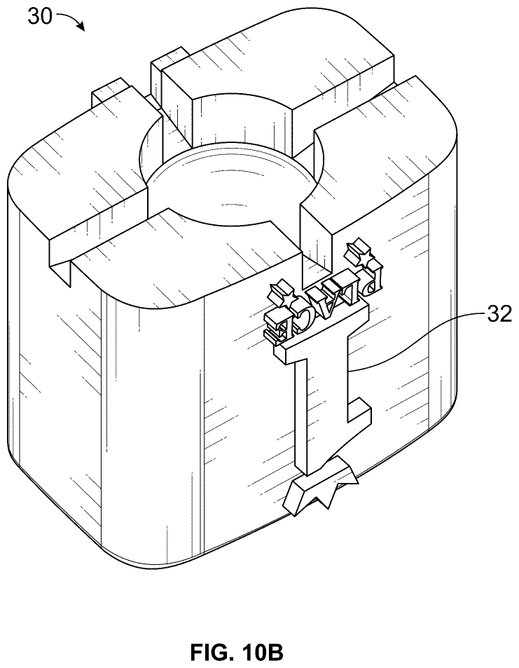

FIG. 10A shows the upwardly extending portion 22 and ribs 24a. FIG. 10B shows the underside of the edible portion 30. The base portion 20 has a plate 24, which forms the upper surface of the base portion 20. The base portion 20 has an upwardly extending portion 22 and the plate 24 has ribs 24a. The upwardly extending portion 22 and ribs 24a support or otherwise affix and secure the edible portion 30 to the upper side of the base portion 20. During the molding of the edible portion 30, the edible portion 30 bonds to the base portion 20 and therefore the edible portion 30 becomes secure to the base portion 20. Moreover, the upwardly extended portion 22 may occupy a cavity within the edible portion 30. The upwardly extended portion 22 is thinner nearer the plate 24 and thicker farther from the plate 24. Since the edible portion 30 forms around the upwardly extended portion 22, the cavity of the edible portion 30 that the upwardly extended portion 22 occupies is smaller nearer the plate 24 and bigger farther from the plate 24. Since the thicker portion of the upwardly extended portion 22 may not pass through the smaller portion of the cavity, the edible portion 30 may not separate from the upwardly extended portion 22. Hence, the edible portion is further secured to the base portion 20. Since the edible portion 30 is secured to the base portion 20, the edible portion 30 is fixed; there is no relative movement between the edible portion 30 and the base portion 20.

FIG. 10A further shows the ribs 24a separating the plate 24 into multiple sections 24b and the upwardly extending portion as a decorative ball 22a. Each section 24b is a portion of the plate 24. The ribs 24a form the boundaries between the sections 24b. Additionally, the upwardly extending portion 22 may be provided as a decorative ball 22a for aesthetic purposes. In the current embodiment, the decorative ball 22a may be provided as a baseball, basketball, football, or soccer ball. Since different ring candy confection apparatus 10 have different decorative balls 22a, the user may be incentivized to collect multiple ring candy confection apparatus 10 to have one ring candy confection apparatus 10 with each decorative ball 22a. Also, the edible portion 30 is provided as a transparent or partially transparent material thus making the upwardly extending portion 22 or decorative ball 22a visible through the edible portion 30. In other words, the ring candy confection apparatus 10 is a combined box-like edible portion 30 with a viewable object, the decorative ball 22a, on a ring, the finger-grasping portion 26. The edible portion 30 has decoration 32 on its sides for aesthetic purposes, as shown in FIG. 10B. The partial transparency of the edible portion 30 and the decoration 32 provides aesthetic value to the ring candy confection apparatus 10 prior to the consumption of the edible portion 30.

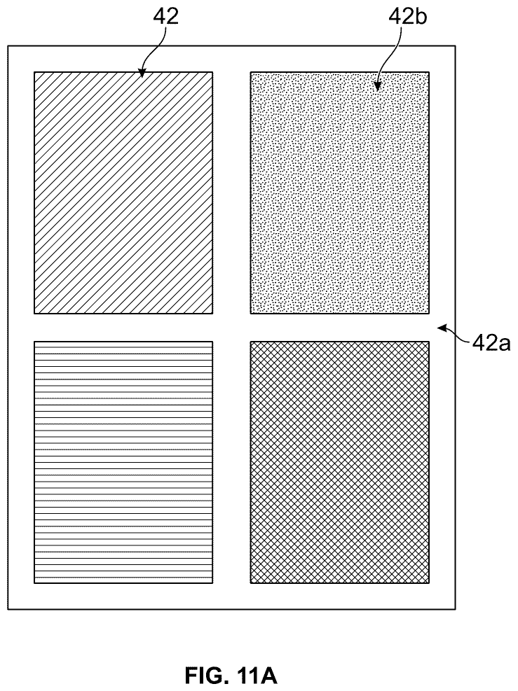

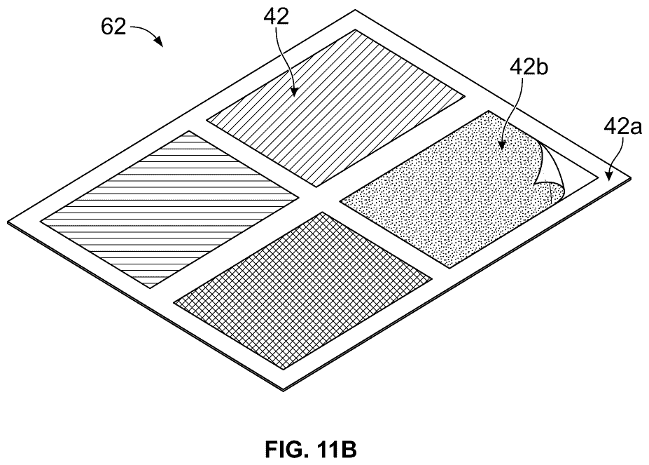

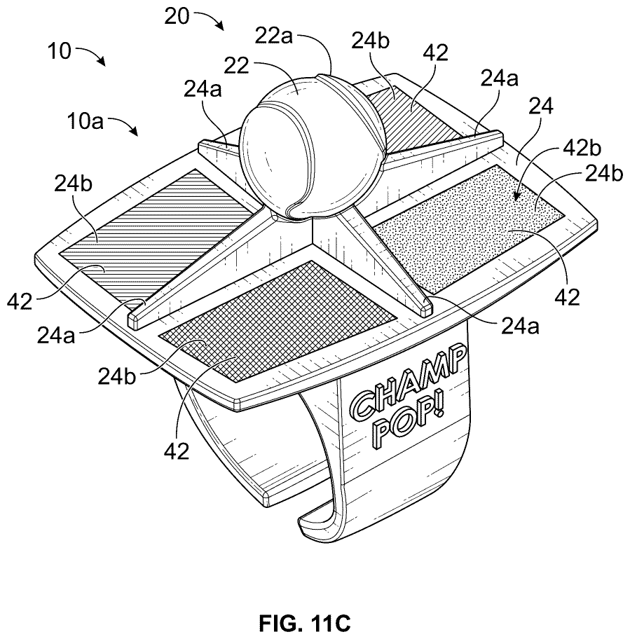

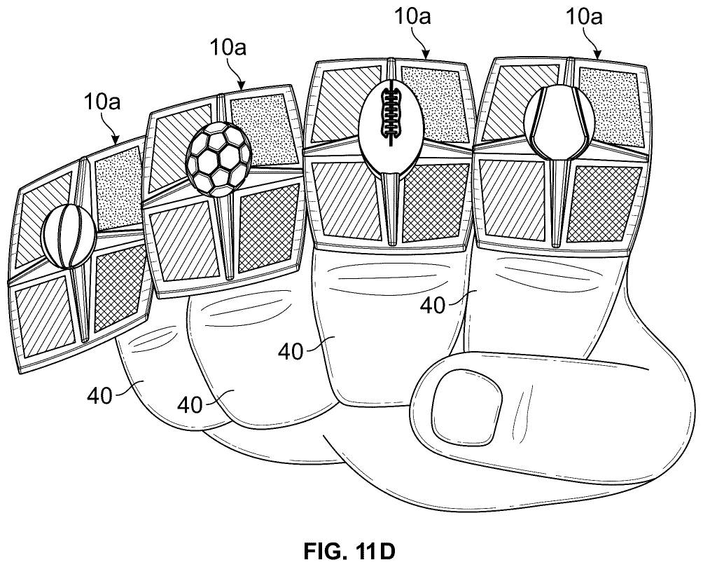

FIG. 11A shows stickers 42. The stickers 42 are given to the user on sticker sheet 42a. FIG. 11B shows the removal of the stickers 42 from sticker sheet 42a. FIG. 11C shows the placement of the stickers 42 on the sections 24b. A particular configuration of the placement of the stickers 42a on the sections 24b form an image 42b. Each sticker 42 shows a quadrant of image 42b corresponding its position for each section 24b. For example, the sticker showing the upper left quadrant is placed in the upper left section 24b. Therefore, the stickers 42 form a puzzle; each sticker 42 must be placed on its corresponding section 24b to form an image 42b. If the stickers are not placed on their corresponding section 24b, the image 42b is not formed.

Additionally, the stickers 42 may not be placed unless the edible portion 30 is removed from the base portion 20 as the edible portion 30 blocks the placement of stickers 42 on the base portion 20 while the edible portion 30 is secured to the base portion 20. Requiring the user to consume the edible portion 30 prior to applying stickers 42 provides a reward and incentive for finishing the consuming the entirety of the edible portion 30. FIG. 11D shows plural ring candy confection apparatus 10 as a decorative elements 10a secured to plural fingers 40. The transformation of the ring candy confection apparatus 10 into a decorative element 10a allows the ring candy confection apparatus 10 to provide value after edible portion 30 is consumed as the decorative element 10a provides aesthetic value. The user may secure plural ring candy confection apparatus 10 or decorative elements 10a to plural fingers 40, which may provide additional aesthetic value. Additionally, if different ring candy confection apparatus 10 have different stickers 42 which form different images 42b, the ring candy confection apparatus 10 may become collectables; the user may be incentivized to collected different ring candy confection apparatus 10 with different stickers 42 applied. Also, as different ring candy confection apparatus 10 may have different decorative balls 22a, the user may also be incentivized to collect different ring candy confection apparatus 10 with different stickers 42 applied.

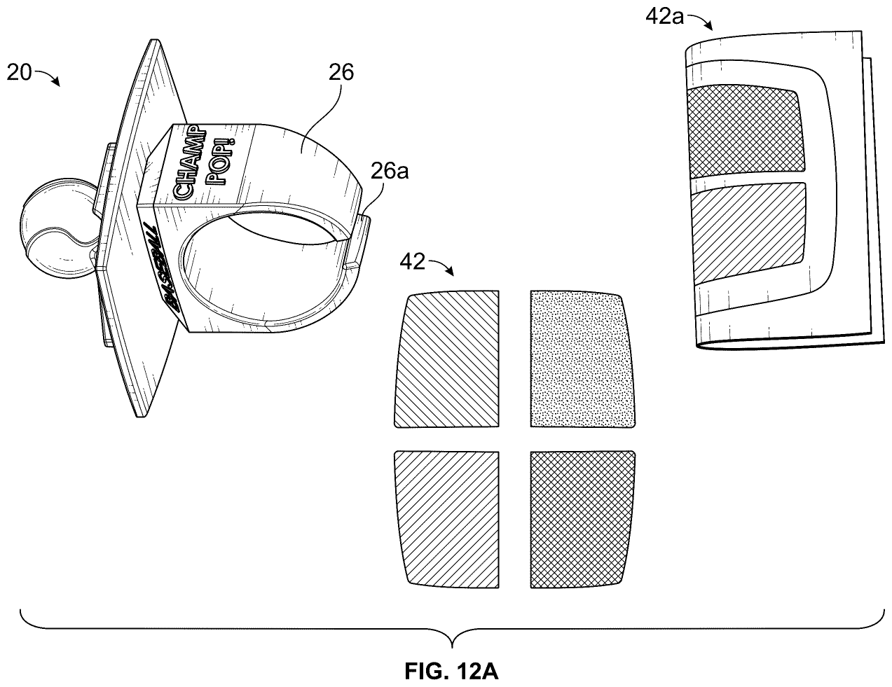

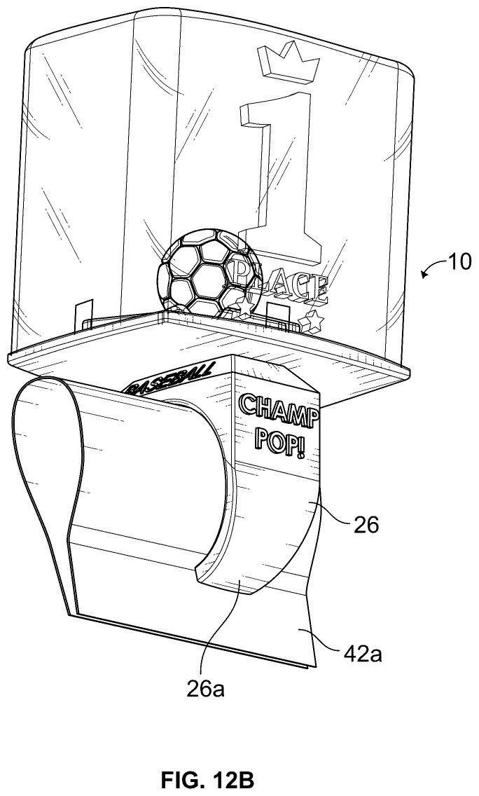

FIG. 12A shows the stickers removed from the sticker sheet. FIG. 12B shows the sticker sheets 42a being stored within the gap 26a of the finger-grasping portion 26. The sticker sheet 42a is folded inward to keep the stickers 42 within the finger-grasping portion 26 and hence the stickers 42 do not contact the edible portion 30. The stickers 42 may be placed within the gap 26a of the finger-grasping portion 26 for packaging. If the stickers 42 touch the edible portion 30 within the packaging, the stickers 42 may get sticky from the edible portion 30. The stickers 42 being sticky is not desirable as sticky stickers 42 may annoy the user.

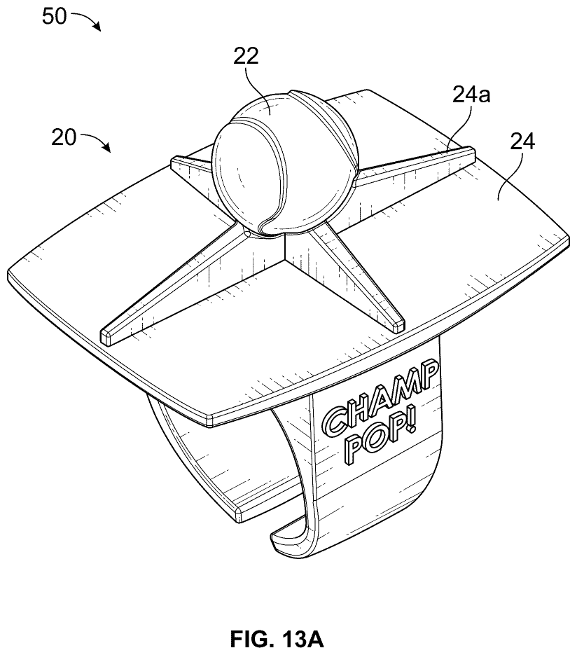

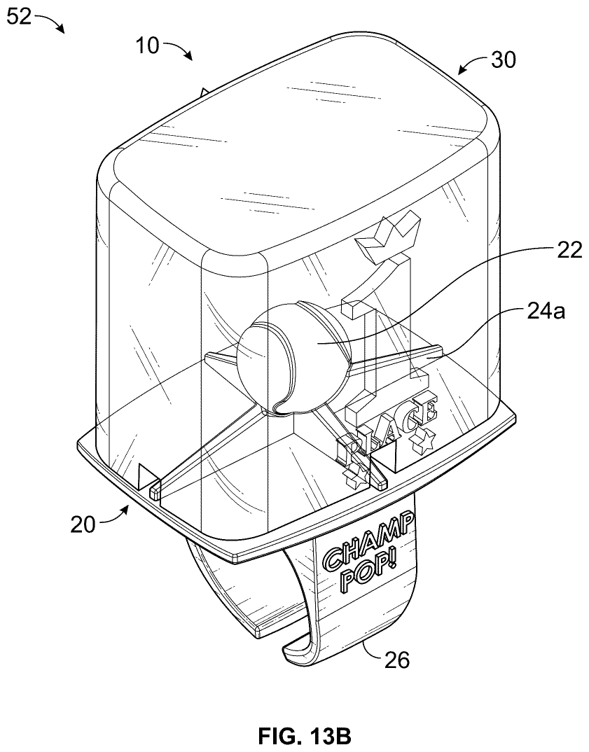

FIGS. 13A and 13B show the methods of manufacturing and using the ring candy confection apparatus. First, as shown in FIG. 13A, the base portion 20 is formed 50. The base portion 20 may be formed 50 through a molding process. Second, as shown in FIG. 13B, the edible portion 30 is formed 52 directly on the base portion 20. The edible portion 30 is formed through molding and the base portion 20 is part of the mold for forming 52 the edible portion 30. As such, when the edible portion 30 becomes solid during the molding process, the edible portion 30 will bond to the base portion 20. Therefore, the edible portion 30 is secured and supported by the base portion 20. The edible portion 30 is formed around the upwardly extending portion 22 and furthermore secures the edible portion 30 to the base portion 20.

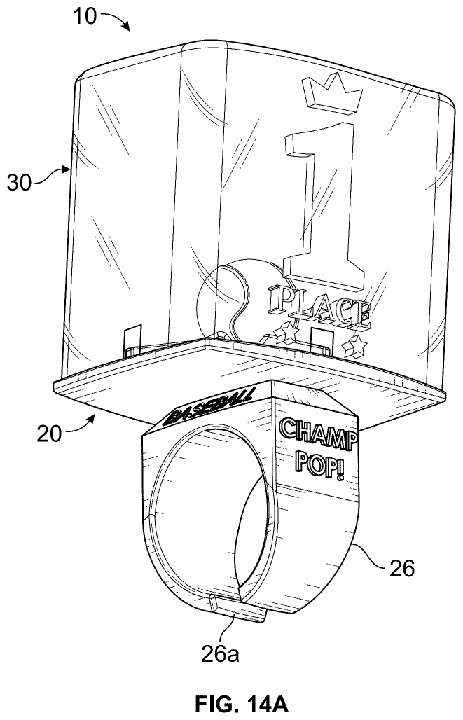

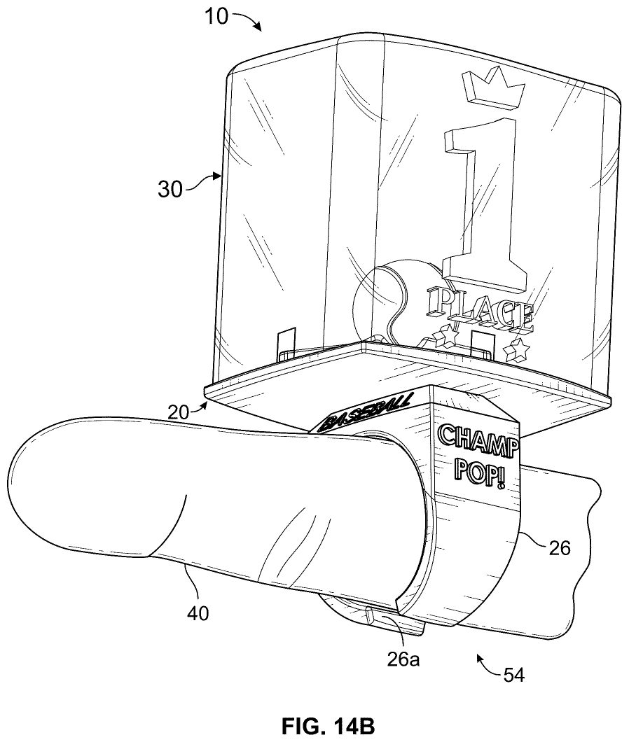

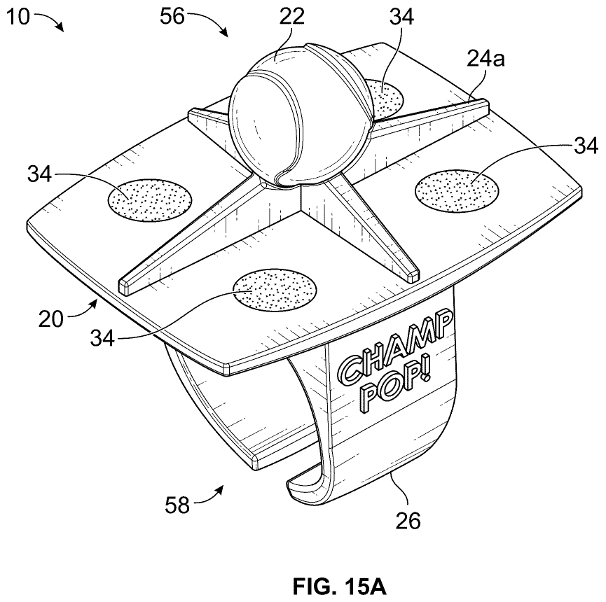

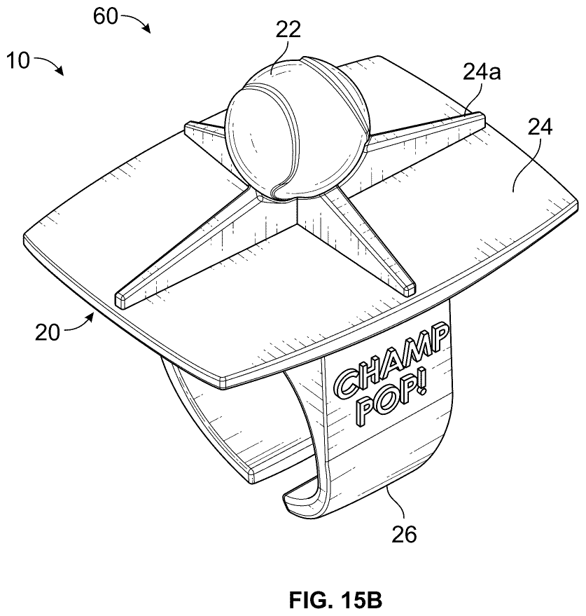

Next, the finger-grasping portion 26 is secured 54 to the finger, as shown in FIGS. 14A and 14B. Securing 54 the finger-grasping portion to the finger accommodates for different sizes. The edible portion 30 is then consumed 56 by the user, as shown in FIG. 15A. Most of the edible portion 30 is gone. However, some germs and debris 34 may remain. The base portion 20 may also be sticky from any leftover debris 34. It is therefore desirable to clean the base portion 20. The next step is to remove 58 the finger-grasping portion 26 from the finger 40. As shown in FIG. 15B, the plate 24, ribs 24a and upwardly extruding portion 22 of the base portion 20 are cleaned 60 of any remaining edible portion 30 debris 34, and germs. The ring candy confection apparatus 10 is now clean from any germs and stickiness from consuming the edible portion 30.

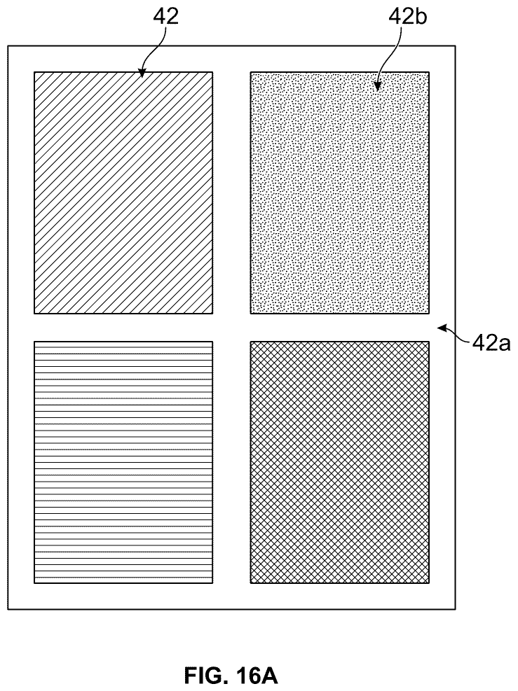

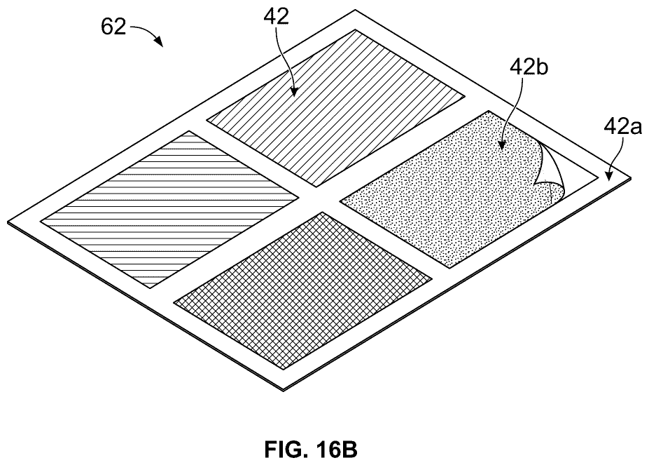

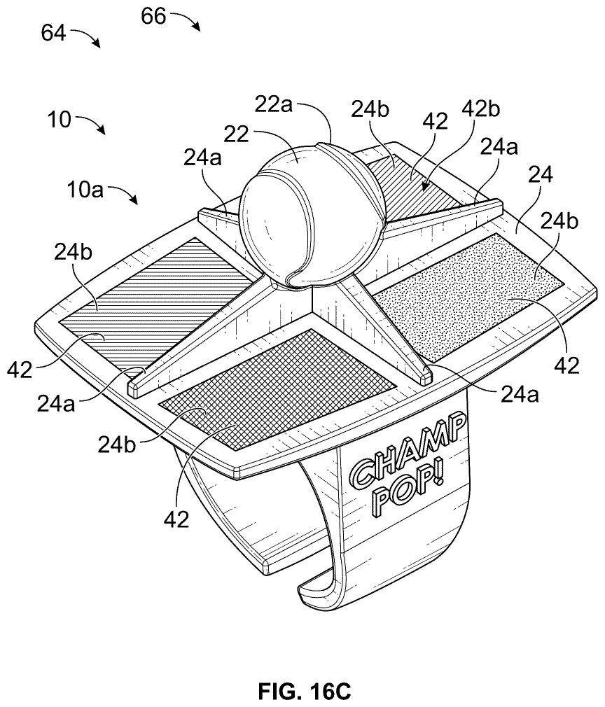

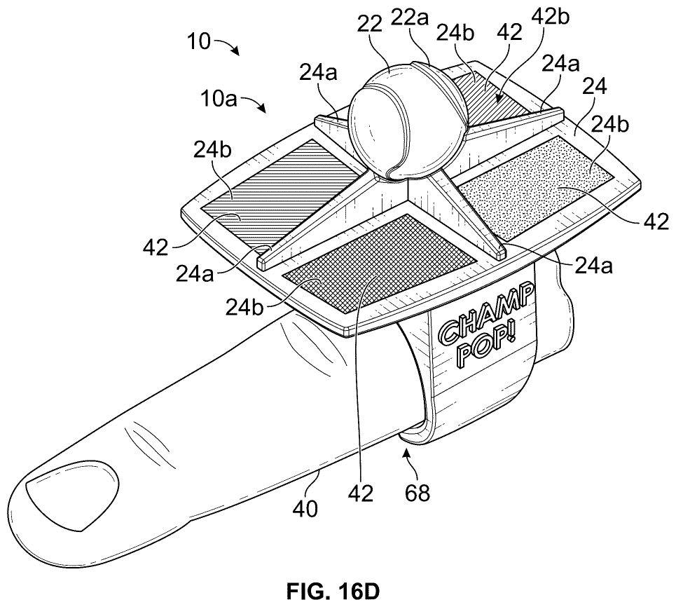

FIGS. 16A, 16B and 16C show the application of the stickers. FIG. 16A shows the stickers 42 on the sticker sheet 42a. FIG. 16B shows the stickers 42 being removed 62 from the sticker sheet 42a and FIG. 16C show the stickers 42 being applied 64 to their respective sections 24b on the base portion 20. The stickers 42 on the base portion 20 form 66 an image 42b if the stickers 42 are applied to their respective sections 24b. If the stickers 42 are applied to the wrong sections 24b, then an image 42b is not formed. The image 42b formed with the stickers 42 on the base portion 20 makes the ring candy confection apparatus 10 a decorative element 10a with the image 42b and decorative ball 22a. The transformation of the ring candy confection apparatus 10 into a decorative element 10a is for aesthetic purposes. Finally, the finger-grasping portion 26 is secured 68 to the finger 40 again, as shown in FIG. 16D.

In summary, FIGS. 13A, 13B, 14A, 14B, 15A, 15B, 16A, 16B, 16C and 16D show the method of manufacturing and usage of the ring candy confection apparatus. FIG. 13A shows the forming 50 of the base portion 20. FIG. 13B shows the forming 52 of the edible portion 30. FIGS. 14A and 14B show the securing 54 of the finger-grasping portion 26. FIG. 15A shows the consumption 56 of the edible portion 30 and the removal 58 of the finger-grasping portion 26 from the finger 40. FIG. 15B shows the cleaning 60 of the plate 24, ribs 24a and upwardly extruding portion 22 of any debris 34. FIGS. 16A and 16B show the removal 62 of the stickers 40 from sticker sheet 42a. FIG. 16C shows the application 64 of the stickers 40 and forming 66 an image 42b. FIG. 16D shows the user securing 68 the finger-grasping portion 26 again.

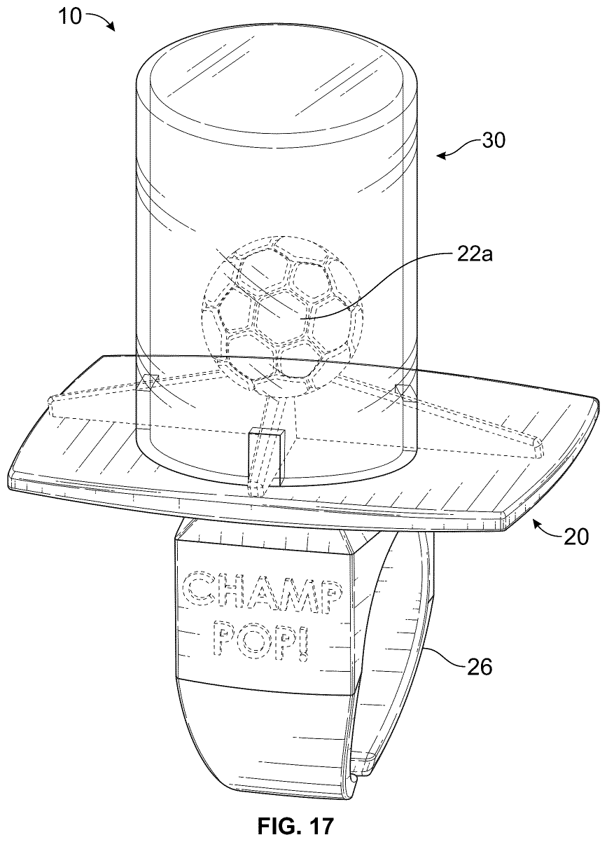

FIG. 17 shows the ring candy confection apparatus 10 with instant inventions showing the candy with further radius of curvature combined for object viewing. The edible portion 30 is provided as a cylinder or other round object. The edible portion 30 may be provided in shapes other than a box or cylinder. The edible portion 30 is provided as a transparent candy so that the decorative ball 22a is viewable through the edible portion 30.

From the foregoing, there has been provided a detailed description and features for an improved apparatus and the methods as well assembling puzzle game sticker candy apparatus base portion securing and supporting said edible portion; the base portion having ribs and an upwardly extending portion; the base portion having a finger-grasping portion. While a particular embodiment of the present invention has been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustrations only, and not as limitations. The actual scope of the invention is to be defined by the subsequent claims when viewed in their proper perspective based on the prior art.

What is claimed is:

1. A ring candy confection apparatus comprising:
an edible portion;
a base portion having a top side and a bottom side, including a finger-grasping portion on the bottom side of said base portion;
at least one pedestal having one or more upwardly extending portions from the top side of said base portion, the upwardly extending portions providing intermediate partitions upon the top side of said base portion for securing and supporting said edible portion; and
an adhesive decorative element for positioning on the top side of the base portion between the intermediate partitions on the top side of said base portion.

2. The ring candy confection apparatus of claim 1, wherein said edible portion comprises molded candy, the pedestal upwardly extending portions and intermediate partitions providing an interference friction fit with the molded candy edible portion to secure the edible portion therewith and thereby being fixed to the upper side of the base portion.

3. The ring candy confection apparatus of claim 2, wherein the intermediate partitions on the top side of said base portion comprise ribs on the base portion supporting the edible portion thereon.

4. The ring candy confection apparatus of claim 2, wherein the upwardly extending portion supports a sports ball object of various shapes decorative in relation to the finger-grasping portion and top side base portion raised therefrom.

5. The ring candy confection apparatus of claim 4, wherein the upwardly extending portion supports the sports ball object in relation to the finger-grasping portion and top side base portion raised to appear for a floating illusion, with the molded candy edible portion being at least partially transparent.

6. The ring candy confection apparatus of claim 1, wherein the finger-grasping portion comprises a pair of bendable plastic extensions and includes a gap between the finger-grasping portion bendable plastic extensions facilitate securing to fingers of different sizes.

7. The ring candy confection apparatus of claim 1, wherein the adhesive decorative element comprises a plurality stickers of a sticker sheet, wherein each sticker may be removed from the sticker sheet and applied in a particular placement configuration.

8. The ring candy confection apparatus of claim 7, wherein the stickers may be placed only after the edible portion is removed from the base portion.

9. The ring candy confection apparatus of claim 6, wherein the adhesive decorative element comprises a plurality stickers of a sticker sheet, and wherein the gap in the finger-grasping portion further facilitates folding the sticker sheet inward for placing the sticker sheet at gap of the finger-grasping portion distancing to prevent the stickers from touching the edible portion.

10. The ring candy confection apparatus of claim 7, wherein particular placement configuration of the plurality of stickers forms an image with the stickers combines to allow the ring candy confection apparatus to become a decorative element with the formed image and upwardly extending portion.

11. A ring candy confection apparatus comprising:
an edible portion molded candy;
a base portion having a top side and a bottom side, including a finger-grasping portion on the bottom side of said base portion;
at least one pedestal having one or more upwardly extending portions from the top side of said base portion, the upwardly extending portions providing intermediate partitions upon the top side of said base portion for securing and supporting said edible portion, the pedestal upwardly extending portions and intermediate partitions providing an interference friction fit with the molded candy edible portion to secure the edible portion therewith and thereby being fixed to the upper side of the base portion; and
a decorative object of a sports ball shape in relation to the finger-grasping portion and top side base portion raised with the upwardly extending portion to support the sports raised to appear as a floating illusion, with the molded candy edible portion being at least partially transparent.

12. The ring candy confection apparatus of claim 11, wherein the intermediate partitions on the top side of said base portion comprise ribs on the base portion supporting the edible portion thereon.

13. The ring candy confection apparatus of claim 11, comprising an adhesive decorative element for positioning on the top side of the base portion between the intermediate partitions on the top side of said base portion.

14. The ring candy confection apparatus of claim 11, wherein the finger-grasping portion comprises a pair of bendable plastic extensions and includes a gap between the finger-grasping portion bendable plastic extensions facilitate securing to fingers of different sizes.

15. A method of assembling a ring candy confection, comprising:
forming a base portion with at least one pedestal having one or more upwardly extending portions with plate sections between the top side of said base portion;
forming a consumable edible portion at a top side of said base portion;
securing a finger-grasping portion at a bottom side of said base portion;
cleaning the at least one pedestal having one or more upwardly extending portions from the top side of said base portion of remaining edible portion and debris;
providing adhesive decorative element stickers from a sticker sheet;
applying stickers to the plate sections of the base portion; and
forming an image particular placement configuration using the stickers applied to the plate sections on the base portion.

16. The method of assembling a ring candy confection of claim 15, wherein said edible portion comprises molded candy, the pedestal upwardly extending portions and intermediate partitions providing an interference friction fit with the molded candy edible portion to secure the edible portion therewith and thereby being fixed to the upper side of the base portion.

17. The method of assembling a ring candy confection of claim 16, wherein the upwardly extending portion supports a sports ball object decorative of various shapes in relation to the finger-grasping portion.

18. The method of assembling a ring candy confection of claim 17, wherein the intermediate partitions on the top side of said base portion comprise ribs on the base portion supporting the edible portion thereon.

19. The method of assembling a ring candy confection of claim 18, wherein particular placement configuration of the plurality of stickers between ribs on the base intermediate partitions forms an image with the stickers combines to allow the ring candy confection apparatus to become a decorative element with the formed image and upwardly extending portion.

20. The method of assembling a ring candy confection of claim 19, wherein the upwardly extending portion supports a sports ball object decorative of various shapes in relation to the finger-grasping portion and top side base portion raised therefrom for a floating illusion, with the molded candy edible portion being at least partially transparent.
